(19) United States
(12) Patent Application Publication
(10) Pub. No.: US 2026/0208078 A1
(43) Pub. Date: Jul. 23, 2026

(54) MICRO-FIBRE FILTER CARTRIDGE AND FILTER UNIT

(71) Applicant: James Brian SIRMON, Bude, Cornwall (GB)

(72) Inventor: James Brian SIRMON, Bude, Cornwall (GB)

(21) Appl. No.: 19/138,880

(22) PCT Filed: Dec. 14, 2023
(86) PCT No.: PCT/IB2023/062674

§ 371 Date: Jun. 13, 2025

(30) Foreign Application Priority Data
Dec. 16, 2022 (GB) 2219038.3

(51) Int. Cl. B01D 35/30; B01D 27/08; B01D 27/10

(52) U.S. Cl. CPC B01D 35/30; B01D 27/08; B01D 27/101; B01D 27/108; B01D 2201/04; B01D 2201/16; B01D 2201/24; B01D 2201/291; B01D 2201/306; B01D 2201/36; B01D 2201/4069

(57) ABSTRACT

A filter unit is described having a scissor lift mechanism to assist installing the cartridge. A recyclable filter cartridge with a reduced risk of failure has a delivery spool (21) and an uptake spool (22) located within an outer casing (20) which includes a partition wall (24) having mutually opposed wall portions (24a, 24b). A filter medium (26) wound about the delivery spool and the uptake spool is moved across a filtration window (25) in an indexing direction (A). The mutually opposed wall portions (24a, 24b) are configured such that the filter medium (26) is constrained to adopt a curved configuration in the indexing direction. The window (25) has transverse bars (29) which are recessed and offset on opposite sides of the filter medium.

### TECHNICAL FIELD OF THE INVENTION

This invention relates to a micro-fibre filter cartridge and a filter unit incorporating the cartridge.

### BACKGROUND

GB 2581790-A discloses a micro-fibre filter unit which is suitable for removing micro-fibres from water discharged by a washing machine. Such removal prevents the entry of synthetic micro-fibres into natural water-courses where they have a prolonged detrimental impact upon the natural environment. The micro-fibre filter unit includes a filter cartridge with a delivery spool and an uptake spool located within an outer casing which includes a partition wall having mutually opposed wall portions. A filter medium wound about the delivery spool and the uptake spool is moved across a filtration window in an indexing direction. U.S. Pat. No. 6,168,646 discloses a filter cartridge in which the mutually opposed wall portions contain grids.

In contrast to some applications such as vehicle oil filters, or filters for fish ponds in which the liquid being filtered may undergo multiple passes, a washing machine filter must achieve optimum removal of very fine particles, and furthermore, do so in a single pass. Therefore, the filter medium used in such a filter necessarily has a very fine aperture size or gauge. As a result, a considerable pressure may be exerted across the filter in use, which can lead to damage to, or distortion of, the filter medium and increases the risk that significant quantities of unfiltered liquid may bypass the filter. There is also a risk that unfiltered material may jam the filter medium and prevent it from being indexed to bring a clean section into use. Repeated problems or failure of the filter has a detrimental impact on the environment and discourages customers from continuing use.

One objective of the present invention is to increase the reliability of such filters and reduce the chances of failure of the filtration process. A further objective is to encourage unskilled consumers to continue using the filter by ensuring that they have a positive experience with minimum inconvenience and low incidences of failure. Another general objective is to conserve natural resources and minimise the environmental impact of such filters.

### SUMMARY OF THE INVENTION

The present invention proposes a micro-fibre filter unit and cartridge having a number of features which contribute to meeting one or more of the above-stated objectives.

The invention provides a micro-fibre filter unit with a housing (1) containing a filter chamber (55) with an inlet (3) for unfiltered liquid and an outlet (4) for filtered liquid. The filter cartridge (10) is sealably receivable within the filter chamber, and indexing means (40, 41) arranged to drive the uptake spool (22).

In a preferred embodiment the indexing means includes a magnetic coupling (43, 44). The magnetic coupling preferably includes a first magnetic element (43) which is contained in a dry compartment and a second magnetic element (44) which is located in the filter chamber (55). The first magnetic element (43) may be rotatably driven by an electric motor (40).

In another preferred embodiment of the filter unit the housing (1) has a lid (5) which carries a cradle (90) to receive the filter cartridge (10).

A preferred form of the filter unit has a scissor lift mechanism (91, 92) to assist installation of the cartridge. The cradle (90) is preferably secured to the housing (1) by a scissor lift mechanism comprising a pair of pivotably connected arms (91, 92). Further preferred features of the scissor lift mechanism are set forth in the appended claims.

To assist loading into the filter unit the filter cartridge includes a worm gear (100) to rotate the uptake spool (22) and and the indexing means (40, 41) includes a worm screw (101).

In another preferred embodiment of the filter unit a fixed sensor (50) is arranged to measure movement of a magnetic element (51) which rotates with the uptake spool (22) and an electronic controller calculates the length of filter medium (26) which has moved onto the uptake spool.

In further preferred feature of the filter unit the outlet (4) incorporates a spring-loaded shut off valve having a valve member (75) which includes a magnetic element (78) which co-operates with a sensor (79) to detect movement of the valve member when water flows through the outlet and activates electronics within the filter unit.

In further preferred feature of the filter unit the inlet (3) incorporates a spring-loaded shut off valve having a valve member (80) which is biased towards a closed position and a projection (83) on the lid opens the shut off valve when the lid is closed.

Another preferred feature of the filter unit is that a pressure-sensitive bypass valve (56) is included between the inlet (3) and the outlet (4) which opens to allow fluid to flow from the inlet to the outlet bypassing the filter cartridge in the event of a blockage.

The proposed filter cartridge has an outer casing (20) including a delivery portion (20a), an uptake portion (20b) and a partition wall (24) extending between the delivery and uptake portions. The partition wall has mutually opposed wall portions (24a, 24b). A filter medium (26) in the form of a liquid permeable sheet extends between said mutually opposed wall portions (24a, 24b) from the delivery portion to the uptake portion. A filtration window (25) comprises multiple perforations in the mutually opposed wall portions (24a, 24b), and a drive arrangement (22, 23) is included to move the filter medium across the filtration window in an indexing direction (A).

A preferred feature of the present filter cartridge is that the mutually opposed wall portions (24a, 24b) are configured such that, during passage across the filtration window (25), the filter medium (26) is constrained to adopt a curved configuration in the indexing direction (FIG. 9).

In a preferred embodiment the filtration window (25) has a grid formed of transverse bars (29) and guide bars (32). The transverse bars are offset on opposite sides of the filter medium and recessed behind the guide bars. Further preferred features of the filtration window are set forth in the accompanying claims.

In a preferred form of the filter cartridge the uptake portion (20b) of the outer casing (20) contains an uptake spool (22) having projections (72) which engage apertures (73) in the ends of filter medium (26). The uptake spool (22) preferably has a shaft (70) which includes a portion of cruciform cross-section (71).

The invention also provides micro-fibre filter cartridge wherein the uptake spool (22) has bearing surfaces (37) at opposite ends, and one or both of said ends includes at least two baffle plates (36) which surround the bearing surfaces. The baffle plates (36) are preferably radially spaced and circumferentially offset.

In another preferred embodiment the outer casing (20) comprises a plurality of snap-engaged parts (61-64). The snap-engaged parts include front and rear wall components (61, 62), and the front and rear wall components each incorporate one of the mutually opposed wall portions (24a, 24b).

### BRIEF DESCRIPTION OF THE DRAWINGS

The following description and the accompanying drawings referred to therein are included by way of non-limiting example in order to illustrate how the invention may be put into practice. In the drawings:

FIG. 1 is a general view of a micro-fibre filter unit suitable to be installed in the waste water outlet of a washing machine;

FIG. 2 is a rear view of the filter unit;

FIGS. 3A and 3B are a top view and an internal view respectively of a micro-fibre filter cartridge for use in the filter unit;

FIG. 4 is an end view showing the internal components of the filter cartridge;

FIGS. 5A and 5B are enlarged sectional views through the filtration window of the filter cartridge taken in the indexing direction;

FIG. 6 is a general view of one wall portion of the filter cartridge, including inset enlarged and cross-sectional details;

FIG. 7 is an end view of a spool used in the filter cartridge;

FIG. 8 is a sectional view of part of an indexing mechanism included in the filter unit;

FIGS. 9A and 9B are internal end views of the filter cartridge showing, respectively, normal indexing and a condition which prevents indexing of the filter medium;

FIGS. 10A and 10B are diagrammatic sectional views of the filter unit showing, respectively, a normal filtration condition and a fault condition caused by an undetected blockage of the filter medium;

FIGS. 11A and 11B are general views of the filter cartridge showing two stages of assembly;

FIGS. 12A and 12B are side views of one of the spools to show connection of the filter medium;

FIGS. 12C and 12D are cross-sections through the spool showing connection of the filter medium;

FIGS. 13A and 13B are sectional views of an outlet valve used in the filter unit showing open and closed conditions respectively;

FIGS. 14A and 14B are sectional views of an inlet valve used in the filter unit showing closed and open conditions respectively;

FIGS. 15A-15D are partial side views of the filter unit showing various stages in removal of the filter cartridge;

FIGS. 16A and 16B are end views of the filter cartridge showing the drive coupling disengaged and engaged respectively;

FIG. 17 is a diagrammatic illustration to show that the cartridge can only be inserted into the filter unit in one orientation.

### DETAILED DESCRIPTION OF THE DRAWINGS

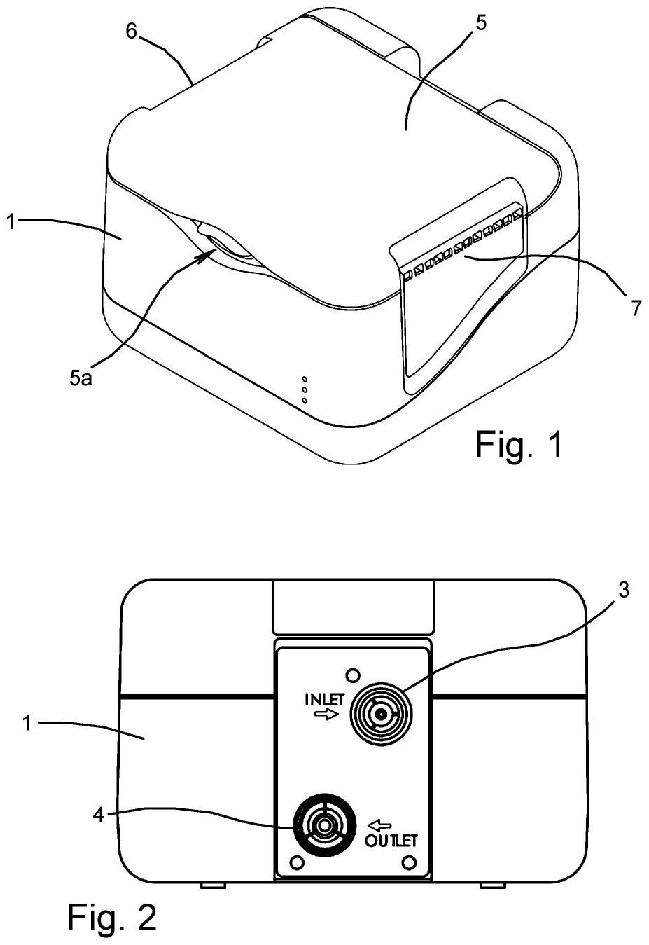

Referring firstly to FIG. 1, the micro-fibre filter unit shown in the drawing is suitable for connection in the water outlet hose of a washing machine. The filter unit includes a housing 1 which contains a filter chamber. The rear of the filter, FIG. 2, is provided with an inlet 3 through which unfiltered liquid can be supplied to the filter chamber, and an outlet 4 through which filtered liquid leaves the unit. The housing is provided with a lid 5 through which a filter cartridge, described below, may be inserted into the filter chamber, with a finger notch 5a for raising the lid. Clips 6 and 7 on opposite sides of the housing 1 enable the lid 5 to be sealably secured in its closed position. When installed in the filter, the cartridge divides the filter chamber into inlet and outlet chambers which respectively connect with the water inlet 3 and the water outlet 4. Leak-proof seals also make sealing contact with the filter cartridge so that, in normal use, unfiltered water cannot leak between the inlet and outlet chambers.

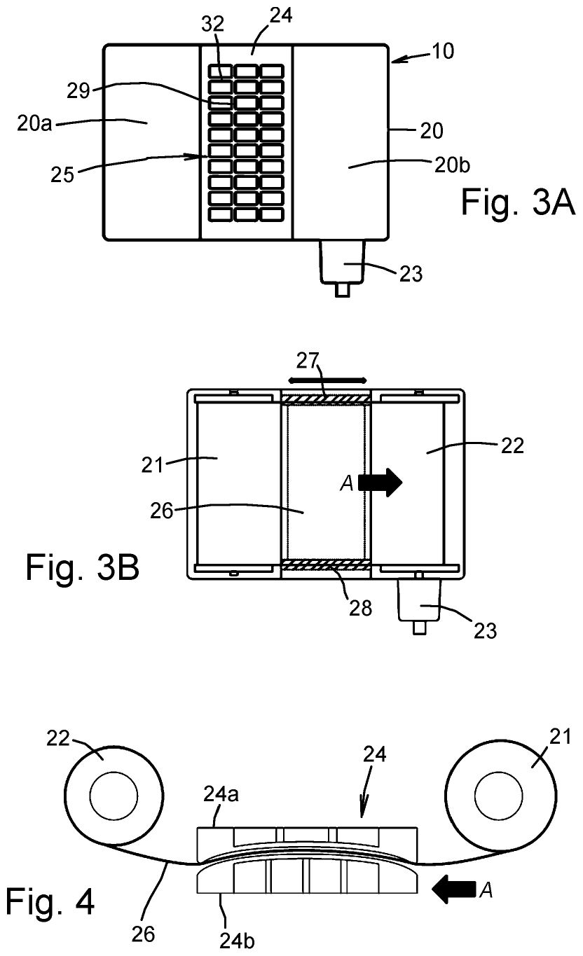

Referring now to FIGS. 3A and 3B, the micro-fibre filter cartridge 10 has an outer casing 20. The casing includes a delivery portion 20a which contains a delivery spool 21 and an uptake portion 20b which contains an uptake spool 22 rotatably mounted within the respective portions of the casing. The uptake spool 22 is provided with an external drive coupling 23 which projects from the casing. Part of the casing which extends between the uptake and delivery portions 20a and 20b provides a twin partition wall 24 having a perforated filtration window 25. As shown, these perforations are formed by a grid of transverse bars 29 and intersecting guide bars 32, described further below. A filter medium 26 extends between the spools 21 and 22 along the interior of the perforated partition wall 24. The filter medium is in the form of an elongate liquid permeable sheet which may be formed of paper, cotton or other natural fibres, or synthetic fibres which are preferably recycled e.g. from previously filtered liquid effluent. For convenience the filter medium will be referred to below simply as a “filter paper”. A filter gauge of 5 μm to 20 μm is generally suitable, depending on the size of the micro-fibres being targeted. In a new cartridge most of the filter paper is wound on the delivery spool 21, but in use the filter paper is progressively wound onto the uptake spool 22 by periodic indexing in a direction A indicated by the arrow. It should be noted, however, that it is not essential for the filter paper to be supplied on a delivery spool. It could, for example, be formed into a loose roll or folded in a zigzag manner.

The filter cartridge incorporates a number of features which reduce the risk of jams and leaks bypassing the filter paper. Firstly, as can be seen in FIG. 3A, the filtration window 25 is of generally rectangular shape with its shortest edges parallel to the guide bars 32 and the indexing direction A. Orientating the shortest edges parallel to the pulling direction of the filter paper 26 ensures that the filter paper is optimally tensioned to avoid distortion under pressure and reduces the risk of the filter paper being bypassed by unfiltered liquid at the edge regions indicated by the shaded areas 27 and 28 (FIG. 3B).

In addition, as can be seen in FIG. 4, the mutually opposed wall portions 24a and 24b of the partition wall 24 are configured such that, in the indexing direction A, the filter paper 26 is constrained to adopt a substantially curved configuration. This curved shape translates part of the tension in the filter paper into a normal force pressing the filter paper to the outlet side of the partition wall 24, which again helps to reduce unfiltered bypass flow.

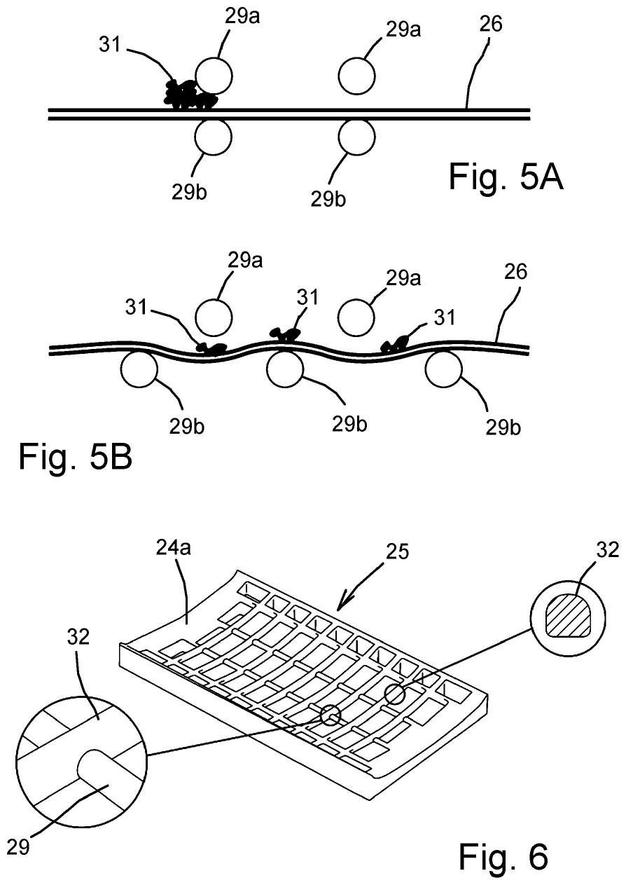

A third feature of the filtration window 25 which helps to reduce potential jamming of the filter paper 26 is illustrated diagrammatically in FIGS. 5A and 5B. The first figure shows a situation where the two sets of transverse bars 29a and 29b are directly opposed, which has been found to cause jamming due to a build up of filtered debris 31 which lodges between the opposing bars 29. Mutually offsetting the bars 29a and 29b in the indexing direction A as shown in the second figure significantly reduces the occurrences of such a build up.

FIG. 6 shows further features of the filtration window which are applied to both of the opposed wall portions. For clarity only part of one such wall portion 24a is shown in the drawing, namely the part which contains the window 25. The drawing shows that the window 25 comprises two sets of intersecting grid elements, namely the transverse bars 29 which extend transverse to the indexing direction A and intersecting guide bars 32 which extend in the direction of travel of the filter paper. Both sets of grid bars 29 and 32 are of rounded, smoothed or curved profile to provide reduced friction on their side facing the filter paper. In addition, the guide bars 32 project towards the filter paper beyond the transverse grid bars 29. The transverse grid bars 29 are thus recessed relative to the guide bars 32 further assisting the passage of retained debris before, during and after the filter paper is indexed.

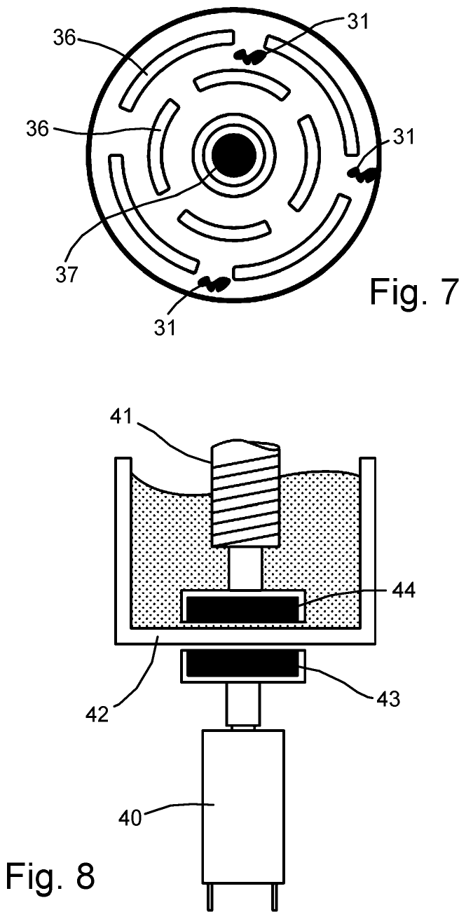

A further area which has been found to cause jamming of the filter paper is the bearing surfaces at both ends of each spool 21 and 22. Referring to FIG. 7, each end of the spool is moulded with integral arcuate baffle plates 36 which are radially spaced and circumferentially offset to provide an indirect path between the outer periphery of the spool and its inner bearing surface 37. Particles of debris 31 therefore tend to get caught between the plates before reaching the bearing surfaces.

In a preferred embodiment the indexing of the filter paper by the spool 21 is achieved by an electric motor. FIG. 8 shows a magnetic coupling between the motor 40, which is contained in a dry compartment within the filter housing 1, and the drive 41 for the filter cartridge which is contained within the wet filter chamber separated by a wall 42. A first magnetic element 43 which is rotatably driven by the motor 40 is magnetically coupled through the wall 42 with a second magnetic element 44 which thus rotates the drive 41. Since the torque required to index the filter paper is normally relatively low, in the event of a jam the available drive torque provided by the magnetic coupling will be exceeded causing the drive to disconnect and thereby avoid damaging the filter paper.

The drive motor 40 is operated to index the filter paper by monitoring or calculating the pressure difference between both sides of the filtration window 25 using a differential pressure sensor or two individual sensors. This pressure difference increases as debris builds up on the filter paper. Once a predetermined trigger pressure is reached, the device initiates spooling of the filter paper to move a clean area into the filtration window.

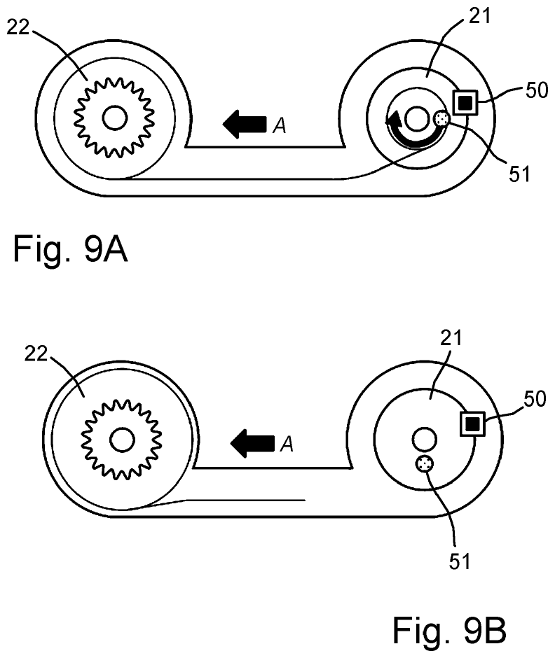

Indexation of the filter paper by a suitable amount may be achieved using a simple turns counter on the delivery spool 21. A more accurate method, illustrated in FIGS. 9A and 9B, is to use a sensor 50 which measures the movement of a magnet or ferrous element 51, which is fixed to the delivery spool 21. An electronic controller in the filter unit calculates the angular velocity, circumference and diameter of the spool and uses this information to accurately calculate the length of the paper spooled over the filtration window. This reduces wastage of the filter paper. In the event of a breakage or jamming of filter paper, or when the paper comes to an end, the delivery spool stops turning when the motor is driven, as illustrated in the second figure. The user is then alerted by illumination of an LED and/or a repeated beeping sound or other audible alert emitted by a sounder.

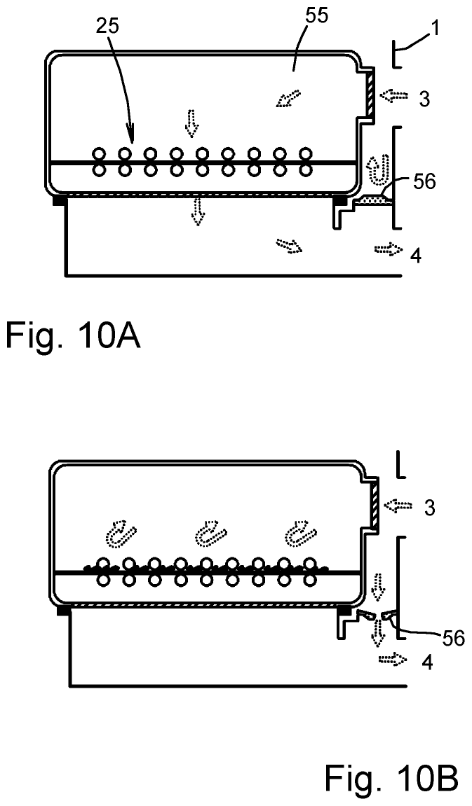

The filter unit incorporates an additional safety feature, illustrated in FIGS. 10A and 10B, which only comes into operation in the event that the filter paper becomes blocked and is not detected, or the indexing system fails. Under normal conditions unfiltered liquid enters the filter chamber 55 through the rear inlet 3 of housing 1. After passing through the filtration window 25 the filtrate leaves through the rear outlet 4, as shown in the first figure. In the event of a blockage, a pressure-sensitive bypass valve 56 allows fluid to pass between the inlet and outlet, avoiding the filter, as shown in the second figure. This safety feature therefore operates to relieve excessive pressure in the unit if the pressure gets too high.

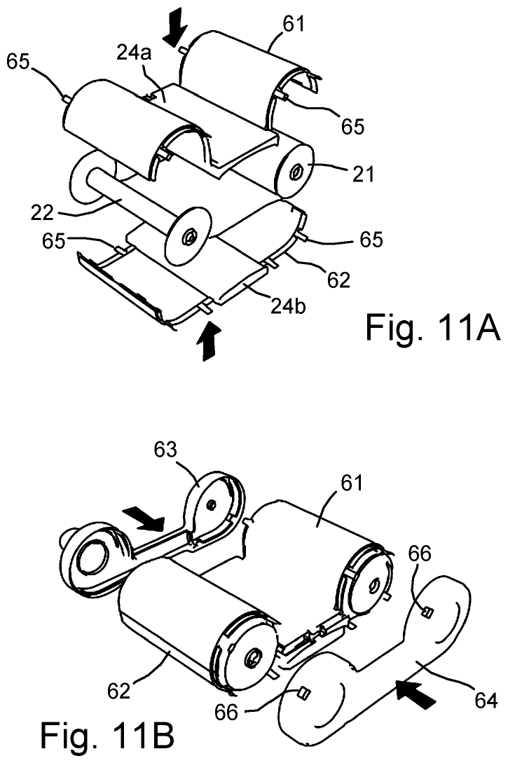

To reduce waste and conserve natural resources the cartridges used in the filter are intended to be reusable and fully recyclable. As shown in FIGS. 11A and 11B, the casing 20 of the filter cartridge 10 is formed of injection moulded components 61-64 which snap together. Front and rear wall components 61 and 62 incorporate the opposable portions 24a and 24b of the partition wall and enclose the two spools 20 and 21, as shown in the first figure. The opposite ends of the two wall components 61 and 62 are formed with resilient lugs 65. As shown in the second figure, two end caps 63 and 64 are formed with retaining holes 66, so that when the end caps are attached to the two wall components the lugs 65 snap into the to holes 66 to hold lock the components together. Following use, the casing can be opened up using a disassembly tool or jig which accesses the lugs through the holes 66 and bends them back to release the end caps. This allows removal of the used filter paper and refurbishment of the internal component parts. The cartridge can then be reassembled with new filter paper for return to customers.

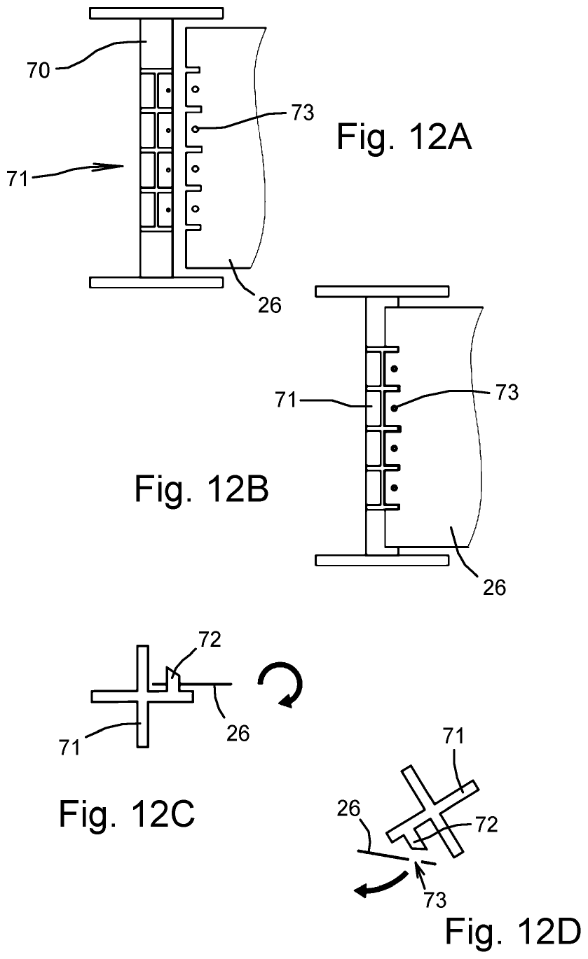

Replacement of the filter paper is facilitated by the configuration of the two spools, as shown in FIGS. 12A to 12D. The shaft 70 of each spool includes a portion of cruciform cross-section 71, at least one arm of which carries a series of tangs 72 with chamfered ends. Each end of the strip of filter paper 26 has a corresponding series of holes 73 which hook over the tangs as shown in FIG. 12C so that the filter paper remains anchored to the respective spools when tensioned. When the casing is disassembled the filter paper can easily be unwound and unhooked from the spools as indicated in FIG. 12D. Whilst tangs are shown in this example, other hook or clip formations could be used to engage the filter paper, enabling the filter paper to be easily connected and then disengaged when the filter paper is finished.

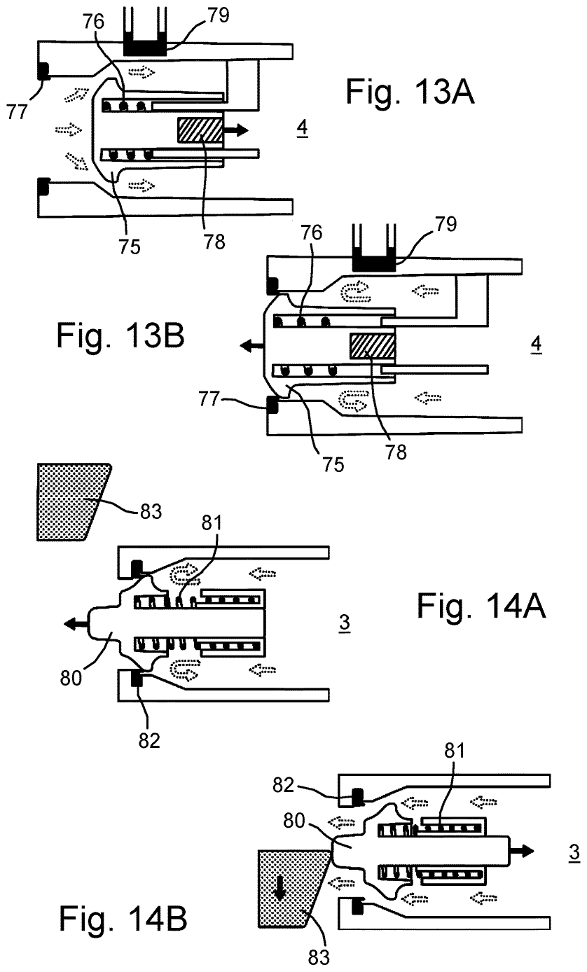

The filter unit incorporates an outlet valve which, as shown in FIGS. 13A and 13B, provide a useful energy saving feature. The flow to the outlet 4 incorporates a valve member 75 which is biased towards a closed position by a compression spring 76. causing the valve to contact a ring seal 77. As shown in the first figure, water pressure moves the valve member away from the seal and allows water to flow through while a connected washing machine is outputting waste water. When there is no flow, the valve closes under spring pressure (second figure) and prevents return flow due to siphoning or gravity effects. Continuously monitoring the water pressure would consume a lot of energy. To enable a long battery life the electronics within the filter unit wake from sleep when the washing machine operates. The valve member 75 incorporates a magnet 78 which co-operates with a fixed reed switch 79, or similar sensor. The reed switch detects movement of the valve member when water flows through the outlet, which activates the electronics and wakes up the filter.

To encourage the average unskilled consumer to use the filter a number of features are included to ensure that they have a positive experience when changing the filter cartridge. As shown in FIGS. 14A and 14B, the flow path from the inlet 3 incorporates a valve member 80 which is biased towards a closed position by a compression spring 81 causing the valve to contact a ring seal 82, as shown in the first figure. When a cartridge is loaded into the filter unit a wedge-shaped projection 83 on the lid 5 opens the inlet valve and allows water to flow through the filter, as seen in the second figure. When the lid is raised the valve member 80 returns to its closed position, which prevents water from entering the device and flooding out or splashing the user if the lid is opened when the washing machine is in use.

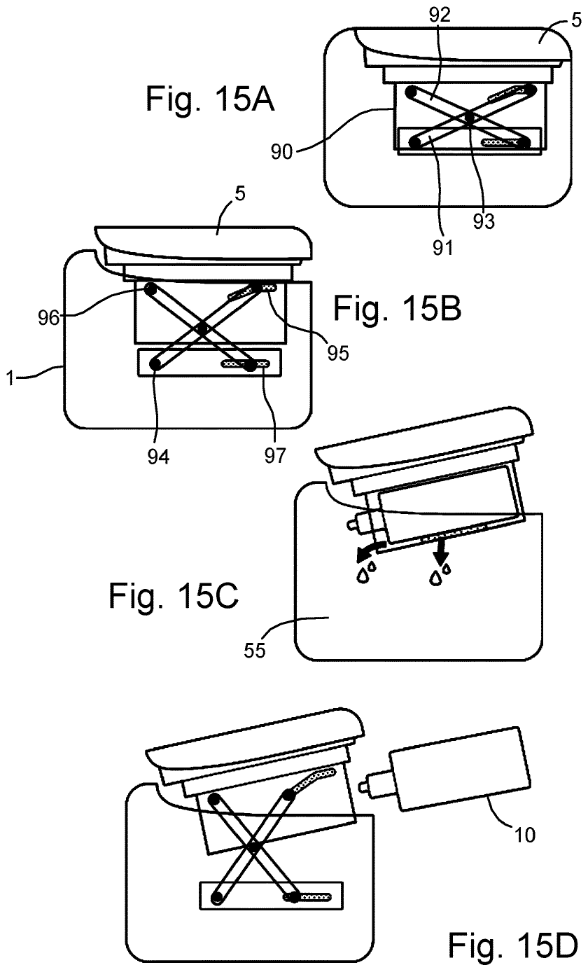

Additional features which ease the process of removing and inserting filter cartridges are shown in FIGS. 15A-D. The underside of the lid 5 carries a cradle 90 to receive the filter cartridge 10. At least one side of the cradle 90 is secured to the housing 1 by a scissor lift mechanism comprising a pair of arms 91 and 92 which are connected together by central pivot 93. One arm 91 has a fixed end 94 which is pivotably connected to the housing 1 and an opposite end which is pivotably restricted to slide along a slot 95 on the cradle. The other arm 92 has a fixed end 96 which is pivotably connected to the cradle and an opposite end which is pivotably restricted to slide along a slot 97 which is fixed relative to the housing. When the lid 5 is closed as in FIG. 15A the arms 91 and 92 are received in ends of the slots which are substantially parallel, but the opposite end of the slot 95 on the cradle is inclined towards the fixed slot 97 as shown. As the lid is raised the cradle initially rises in a parallel condition (FIG. 15B) but as the arm 91 starts to travel along the inclined part of the slot 95 the lid and cradle move to an inclined position as seen in FIG. 15C. This encourages the cartridge 10 to drain into the filter chamber 55 and also presents the cartridge in a convenient position for insertion and removal, as shown in FIG. 15D. Closing the lid reverses the movement of the cradle until the lid is sealably seated, allowing the clips 6 and 7 to be engaged (FIG. 1) and secure the lid in place.

The smoothest action is obtained if similar scissor lift mechanisms are provided on both sides of the cradle 90, but one side could only have a single arm 91 arranged to move along a similar slot 95.

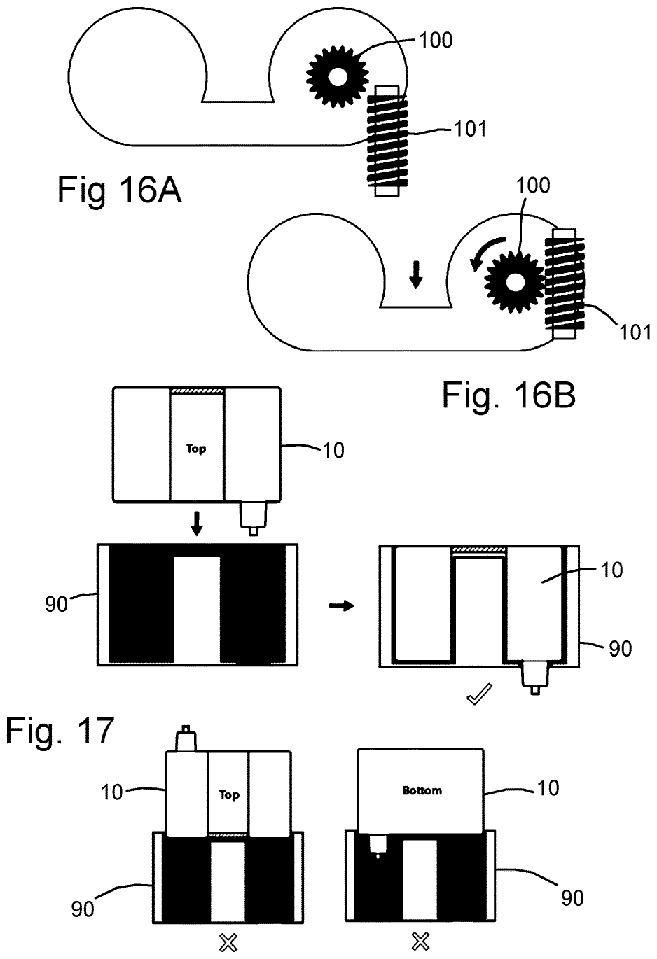

When the cartridge is inserted and removed the external drive coupling 23 is arranged to smoothly engage the drive mechanism shown in FIG. 8. As shown in FIGS. 16A and 16B, the drive coupling includes a worm gear or pinion 100 to enable spooling of the filter paper. When the cradle 90 is at or above the partly raised position of FIG. 15B the worm gear 100 is held clear of a worm screw 101 which is driven from the motor 40. When the lid 5 is closed, the worm gear 100 rolls smoothly onto the worm screw 101, as seen in FIG. 16B, ensuring that the drive mechanism should never clash as the cartridge engages.

It should also be noted that the asymmetrical shape of the filter cartridge 10 ensures that it can only be inserted into the cradle 90 in the correct orientation, as shown in FIG. 17. Any attempt to insert the cartridge in an incorrect orientation will prevent the lid from closing.

Whilst the above description places emphasis on the areas which are believed to be new and addresses specific problems which have been identified, it is intended that the features disclosed herein may be used in any combination which is capable of providing a new and useful advance in the art.

1. A micro-fibre filter unit:
a housing (1) containing a filter chamber (55) with an inlet (3) for unfiltered liquid and an outlet (4) for filtered liquid;
a filter cartridge (10) which is sealably receivable within the filter chamber, said filter cartridge having an outer casing (20), an uptake spool (22), and a filter medium (26) in the form of a liquid permeable sheet;
indexing means (40, 41) arranged to drive the uptake spool (22);
wherein the housing (1) has a lid (5) which carries a cradle (90) to receive the filter cartridge (10).

2. A micro-fibre filter unit according to claim 1 wherein the cradle (90) is secured to the housing (1) by a scissor lift mechanism comprising a pair of pivotably connected arms (91, 92).

3. A micro-fibre filter unit according to claim 2 wherein one arm (91) has a fixed end (94) which is pivotably connected to the housing (1) and an opposite end which is pivotably restricted to slide along a slot (95) on the cradle.

4. A micro-fibre filter unit according to claim 3 wherein the other arm (92) has a fixed end (96) which is pivotably connected to the cradle and an opposite end which is pivotably restricted to slide along a slot (97) which is fixed relative to the housing.

5. A micro-fibre filter unit according to claim 4 wherein the slots (95, 97) include portions which are mutually parallel and at least one of the slots (95) includes a portion which is inclined towards the other slot (97).

6. A micro-fibre filter unit according to claim 1 wherein the filter cartridge includes a worm gear (100) to rotate the uptake spool (22) and and the indexing means (40, 41) includes a worm screw (101).

7. A micro-fibre filter unit according to claim 1 wherein a fixed sensor (50) is arranged to measure movement of a magnetic element (51) which rotates with the uptake spool (22) and an electronic controller calculates the length of filter medium (26) which has moved onto the uptake spool.

8. A micro-fibre filter unit according to claim 1 wherein the outlet (4) incorporates a spring-loaded shut off valve having a valve member (75) which includes a magnetic element (78) which co-operates with a sensor (79) to detect movement of the valve member when water flows through the outlet and activates electronics within the filter unit.

9. A micro-fibre filter unit according to claim 1 wherein the inlet (3) incorporates a spring-loaded shut off valve having a valve member (80) which is biased towards a closed position and a projection (83) on the lid opens the shut off valve when the lid is closed.

10. A micro-fibre filter unit according to claim 1 wherein a pressure-sensitive bypass valve (56) is included between the inlet (3) and the outlet (4) which opens to allow fluid to flow from the inlet to the outlet bypassing the filter cartridge in the event of a blockage.

11. A micro-fibre filter unit according to claim 1 wherein the indexing means (40, 41) includes a magnetic coupling (43, 44).

12. A micro-fibre filter unit according to claim 11 wherein the magnetic coupling includes a first magnetic element (43) which is contained in a dry compartment and a second magnetic element (44) which is located in the filter chamber (55).

13. A micro-fibre filter unit according to claim 12 wherein the first magnetic element (43) is rotatably driven by an electric motor (40).

14. A micro-fibre filter cartridge suitable for use in a micro-fibre filter unit according to claim 1, said filter cartridge including:
an outer casing (20) including a delivery portion (20a), an uptake portion (20b) and a partition wall (24) extending between the delivery and uptake portions, said partition wall having mutually opposed wall portions (24a, 24b);
a filter medium (26) in the form of a liquid permeable sheet extending between said mutually opposed wall portions (24a, 24b) from the delivery portion to the uptake portion;
a filtration window (25) comprising multiple perforations in the mutually opposed wall portions (24a, 24b);
a drive arrangement (22, 23) to move the filter medium across the filtration window in an indexing direction (A);
wherein the filtration window (25) includes transverse bars (29) which extend transverse to the indexing direction (A) and guide bars (32) which extend in the indexing direction (A), and the guide bars (32) project beyond the transverse bars (29) towards the filter medium (26).

15. A micro-fibre filter cartridge according to claim 14 wherein opposing surfaces of the guide bars (32) of both mutually opposed wall portions (24a, 24b) have a curved cross section.

16. A micro-fibre filter cartridge according to claim 14 wherein opposing surfaces of the transverse bars (29a, 29b) of both mutually opposed wall portions (24a, 24b) have a curved cross section.

17. A micro-fibre filter cartridge according to claim 14 wherein the transverse bars (29a, 29b) of both mutually opposed wall portions (24a, 24b) are mutually offset in the indexing direction (A).

18. A micro-fibre filter cartridge according to claim 14 wherein the uptake portion (20b) of the outer casing (20) contains an uptake spool (22) having projections (72) which engage apertures (73) in the ends of filter medium (26).

19. A micro-fibre filter cartridge according to claim 14 wherein the uptake portion (20b) of the outer casing (20) contains an uptake spool (22) having bearing surfaces (37) at opposite ends, and one or both of said ends includes at least two baffle plates (36) which surround the bearing surfaces.

20. A micro-fibre filter cartridge according to claim 19 wherein the baffle plates (36) are radially spaced and circumferentially offset.

21. A micro-fibre filter cartridge according to claim 14 wherein the outer casing (20) comprises a plurality of snap-engaged parts (61-64) which include front and rear wall components (61, 62), and the front and rear wall components each incorporate one of the mutually opposed wall portions (24a, 24b).
